(19) United States
(12) Patent Application Publication
(10) Pub. No.: US 2022/0011126 A1
(43) Pub. Date: Jan. 13, 2022

(54) ROUTE GUIDANCE SYSTEM, ROUTE GUIDANCE METHOD, SERVER, MOBILE TERMINAL, AND STORAGE MEDIUM

(71) Applicant: HONDA MOTOR CO., LTD., Tokyo (JP)

(72) Inventors: Mitsuyoshi Nakamura, Tokyo (JP); Hiroyuki Hazawa, Tokyo (JP); Takashi Fukahori, Tokyo (JP); Kenya Sakurai, Tokyo (JP); Yuji Tsuchiya, Wako-shi (JP); Yoko Ishihara, Tokyo (JP); Shinsuke Kandaka, Tokyo (JP)

(21) Appl. No.: 17/368,101

(22) Filed: Jul. 6, 2021

(30) Foreign Application Priority Data
Jul. 9, 2020 (JP) 2020-118530

(51) Int. Cl. G01C 21/34; E05F 15/70

(52) U.S. Cl. CPC G01C 21/3484; E05Y 2900/531; E05Y 2400/45; E05F 15/70

(57) ABSTRACT

An embodiment of the invention is to provide a route guidance system including: a route search unit that searches a route from a departure point to a destination point; and a route guidance unit that guides a user to the searched route, the route guidance system further including: a state acquisition unit that acquires user state information regarding a state of the user; and a search condition determination unit that determines, based on the user state information acquired by the state acquisition unit, a search condition of the route, the route search unit being configured to search for the route based on the search condition.

### INCORPORATION BY REFERENCE

The present application claims priority under 35 U.S.C. § 119 to Japanese Patent Application No. 2020-118530 filed on Jul. 9, 2020. The content of the application is incorporated herein by reference in its entirety.

### BACKGROUND OF THE INVENTION

### Field of the Invention

The present invention relates to a route guidance system and a route guidance method for guiding a user to a route to a destination point, a server and a mobile terminal used for the route guidance system, and a storage medium storing a program for terminal which is executed by a processor on the mobile terminal.

### Description of the Related Art

In the related art, a system is known that guides a user to a route to a parking spot when the user goes back to the parking spot. For example, Japanese Patent Laid-Open No. 2012-22478 discloses a mobile terminal configured to acquire position information of a vehicle using GPS when a user gets off the vehicle. The mobile terminal determines accuracy of the position information based on a state of GPS waves, and notifies the user to capture a surrounding image when the accuracy does not satisfy predetermined accuracy. Then, when the user goes back to the parking spot, the mobile terminal assists such that the user reaches the parking spot in such a manner of performing route guidance by normal map display to the vicinity of the parking spot in an area away from the parking spot where the position information satisfies the predetermined accuracy, and displaying the captured surrounding image on a display screen in an area around the parking spot where the position information does not satisfy the predetermined accuracy.

In the route guidance to the destination point performed by the mobile terminal, the route search is generally performed to the destination point such that a route distance or a route movement time is the shortest. However, it is sometimes convenient for the user to perform the route search based on the ease of movement (for example, a road width and/or few stairs, steps, and undulations) rather than the route distance or the route movement time depending on the state of the user (for example, a load condition such as possession of luggage or accompaniment of a kid or a use condition of moving assistance equipment such as use of a baby carriage or a wheelchair).

### SUMMARY OF THE INVENTION

The present invention is to provide a route guidance system that guides a user to a route to a destination point to provide a more appropriate route guidance for the user.

A first aspect of the present invention is to provide a route guidance system including: a route search unit that searches a route from a departure point to a destination point; and a route guidance unit that guides a user to the searched route, the route guidance system further including: a state acquisition unit that acquires user state information regarding a state of the user; and a search condition determination unit that determines, based on the user state information acquired by the state acquisition unit, a search condition of the route, the route search unit being configured to search for the route based on the search condition.

According to a second aspect of the present invention, the state acquisition unit acquires the user state information when the user departs from the departure point and/or when the route includes a waypoint and the user departs from the waypoint.

According to a third aspect of the present invention, the destination point is a parking spot of a vehicle used by the user, and the state acquisition unit acquires the user state information when the user gets off the vehicle.

According to a fourth aspect of the present invention, the route guidance system further includes a guidance management unit that manages an operation of guiding the user to the route searched by the route search unit, the guidance management unit being configured to notify a mobile terminal of the user of a notification indicating that route guidance is possible to the destination point when the mobile terminal is within a range of a predetermined distance from the parking spot of the vehicle, which is the destination point.

According to a fifth aspect of the present invention, the guidance management unit guides the user to the route searched by the route search unit via a mobile terminal of any person accompanied by the user when determining, based on the user state information acquired by the state acquisition unit, that the user is in a state of not being capable of receiving the route guidance through the user's own mobile terminal.

According to a sixth aspect of the present invention, the route guidance system further includes a door control unit that controls opening operation of doors of the vehicle, the door control unit being configured to determine, based on the user state information acquired by the state acquisition unit, any of the doors that should be subjected to the opening operation, and to execute the opening operation on the determined target door.

A seventh aspect of the present invention is to provide a route guidance method including: a step in which a route search unit searches for a route from a departure point to a destination point; and a step in which a route guidance unit guides a user to the searched route, the route guidance method further including: a step in which a state acquisition unit acquires user state information regarding a state of the user; and a step in which a search condition determination unit determines a search condition of the route based on the user state information acquired by the state acquisition unit, the route being searched based on the search condition in the step of searching.

An eighth aspect of the present invention is to provide a server including a computer forming the route guidance system according to any one of the aspects and connected to a communication network, the server including the route search unit, the state acquisition unit, and the search condition determination unit.

A ninth aspect of the present invention is to provide a mobile terminal of a user, the mobile terminal forming the route guidance system according to any one of the aspects, the mobile terminal including the route search unit, the search condition determination unit, and the route guidance unit.

A tenth aspect of the present invention is to provide a storage medium storing a program for terminal which is executed by a processor in a computer included in a mobile terminal of a user, the mobile terminal forming the route guidance system according to any one of the aspects, the program for terminal causing the computer to function as the route search unit, the search condition determination unit, and the route guidance unit.

According to the aspects of the present invention, it is possible to guide the user to a more appropriate route depending on the state of the user such as possession of luggage in the route guidance system that guides the user to the route to the destination point.

### BRIEF DESCRIPTION OF THE DRAWINGS

FIG. 1 is a view showing a configuration of a route guidance system according to a first embodiment of the present invention together with an example of a scene in which the route guidance system is used;

FIG. 2 is a diagram showing a configuration of a guidance management server forming the route guidance system shown in FIG. 1;

FIG. 3 is a diagram showing an example of a search condition table used at the time of determining a search condition in the route guidance system shown in FIG. 1;

FIG. 4 is a diagram showing a configuration of a mobile terminal of a user forming the route guidance system shown in FIG. 1;

FIG. 5 is a flowchart showing an operation procedure of the route guidance system shown in FIG. 1;

FIG. 6 is a diagram showing a modified example of the mobile terminal forming the route guidance system shown in FIG. 1;

FIG. 7 is a view showing a configuration of a route guidance system according to a second embodiment of the present invention together with an example of a scene in which the route guidance system is used;

FIG. 8 is a diagram showing a configuration of a guidance management server forming the route guidance system shown in FIG. 7;

FIG. 9 is a diagram showing a configuration of a mobile terminal of a user forming the route guidance system shown in FIG. 7;

FIG. 10 is a diagram showing a configuration of an in-vehicle guidance device mounted on the vehicle and forming the route guidance system shown in FIG. 7; and

FIG. 11 is a flowchart showing an operation procedure of the route guidance system shown in FIG. 7.

### DETAILED DESCRIPTION OF THE PREFERRED EMBODIMENTS

Embodiments of the present invention will be described below with reference to the drawings.

### First Embodiment

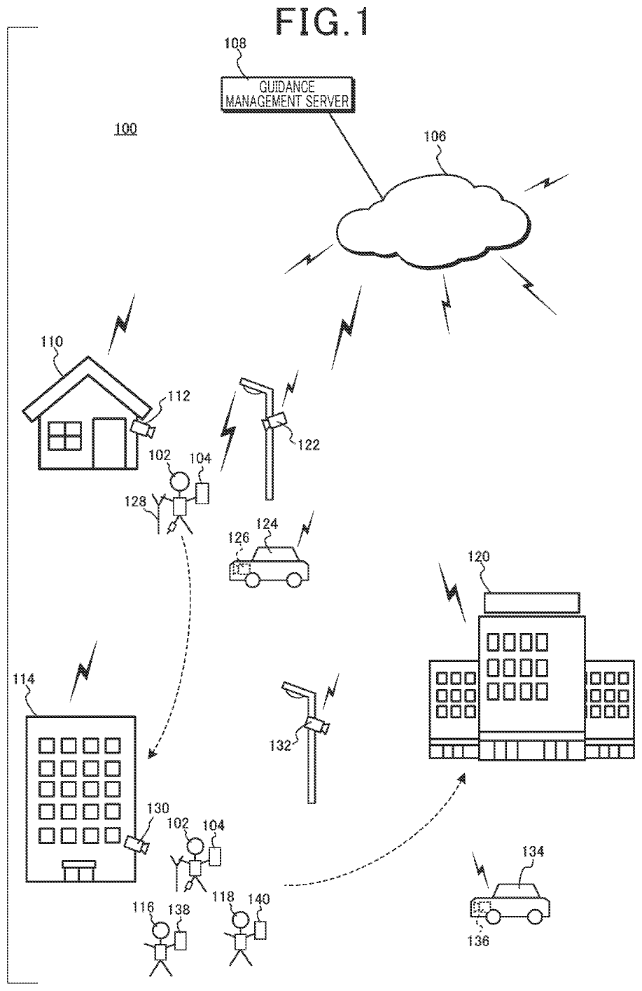

First, a first embodiment of the present invention will be described. FIG. 1 is a view showing a configuration of a route guidance system according to the first embodiment of the present invention together with an example of a scene in which the route guidance system is used. A route guidance system 100 according to the present embodiment includes, for example, a mobile terminal 104, which is a terminal device possessed by a user 102, and a guidance management server 108, which is communicably connected to the mobile terminal 104 via a communication network 106. The communication network 106 can be an open network such as Internet. The mobile terminal 104 is a multifunctional mobile terminal such as a smartphone.

The route guidance system 100 searches for a route from a departure point to a destination point which are input by the user 102 via the mobile terminal 104. Here, the departure point is home 110 of the user 102, for example. The route guidance system 100 is configured to grasp a user's state from, for example, an image captured by a home camera 112 included in the home 110, to search for an appropriate route according to the grasped user's state, and to guide the searched route to the user 102 via the mobile terminal 104. The user 102 is, for example, a registered user registered in advance in the guidance management server 108 as a user who receives a route guidance service.

In the scene shown in FIG. 1, the user 102 is, for example, a university student whose leg is injured, carries the mobile terminal 104 on crutches 128, departs from the home 110, which is a departure point, and moves to a university 114 which is a waypoint. Thereafter, the user 102 moves to a shopping mall 120, which is a destination point, together with persons 116 and 118, who are friends, from the university 114. The user moves to the university 114 being a waypoint, and the shopping mall 120 being a destination point, on foot, for example.

First, when departing from the home 110, the user 102 inputs the home 110, the university 114, and the shopping mall 120 to the mobile terminal 104 as a departure point, a waypoint, and a destination point, respectively, and inputs an instruction of route guidance to the mobile terminal 104 at the same time. The mobile terminal 104 transmits information indicating the input departure point, waypoint, and destination point and a route guidance request to the guidance management server 108 via the communication network 106.

When receiving the route guidance request, the guidance management server 108 acquires current position information of the mobile terminal 104 from the mobile terminal 104 at predetermined time intervals. When detecting from the position information of the mobile terminal 104 that the user 102 departs from the home 110 which is the departure point, the guidance management server 108 acquires images of the user 102 from cameras existing around the mobile terminal 104, for example, from the home camera 112 included in the home 110 being the departure point, a streetlight camera 122 around the home 110, and/or an in-vehicle camera 126 included in a vehicle 124 traveling or parked around the home 110. In addition, the guidance management server 108 acquires user state information regarding the state of the user 102, from the acquired images and the information input to the mobile terminal 104.

Here, the user state information may include information regarding a body condition of the corresponding user (whether the user uses a walking assistance equipment such as a crutch or a wheelchair) and information regarding compositions of accompanying or companion persons (including distinguishment of adults and children).

When acquiring the user state information, the guidance management server 108 determines, based on the acquired user state information, search conditions for searching for a route to the destination point via the waypoint. For example, when the user's state represented by the user state information means the use of the user's walking assistance equipment (for example, the crutch), such search conditions can be determined that “the number of steps in a path is small and a slope is gentle”.

Alternatively, for example, when the user's state represented by the user state information is “accompanied by a plurality of adults” or “accompanied by a kid (a child or a toddler, for example), such search conditions can be determined that “a path width is wide” or “the traffic volume of people or vehicles is small”, respectively. Here, a predetermined width of the path width can be set according to the number of accompanying persons. Further, the guidance management server 108 monitors images captured by the streetlight camera or the in-vehicle camera, for example, and thus the traffic volume in each of the road and the path can be constantly grasped.

In the scene shown in FIG. 1, from the image captured by the home camera 112, the guidance management server 108 detects that the user 102 is using the crutch 128, and as a result, acquires user state information indicating that the “user is using the crutch”. According to the related art, the guidance management server 108 can detect that the user 102 is using the crutch 128, by performing image recognition processing on the image captured by the home camera 112 or the like.

Next, the guidance management server 108 sets the route search condition to “the number of steps in the path is small and the slope is gentle” based on the user state information indicating that the “user is using the crutch”. In addition, the guidance management server 108 searches for a route from the position of the home 110 being the departure point to the waypoint, for example, a route having the smallest number of operation steps, according to the set route search condition. Here, the route according to the route search condition is searched from route candidates having a route distance equal to or less than an upper limit distance, which is calculated by addition of a predetermined margin distance to the shortest route distance from the departure point to the waypoint.

Then, the guidance management server 108 transmits information (route information) of the searched route to the mobile terminal 104 of the user 102. The mobile terminal 104 received the route information displays a map on a display device included in the mobile terminal according to the related art and displays the route, which is indicated by the received route information, in a superimposed manner on the map, thereby providing the route guidance to the user 102.

Subsequently, when the user 102 arrives at the university 114 being the waypoint and finishes the work, and then departs from the university 114 toward the shopping mall 120 being the destination point, the guidance management server 108 detects such movement from changes in the position information received from the mobile terminal 104.

When detecting that the user 102 departs from the university 114 being the waypoint, the guidance management server 108 acquires an image of the user 102 from the camera existing around the mobile terminal 104. The camera may be, for example, an on-site camera 130 installed in the building of the university 114.

Then, the guidance management server 108 acquires user state information indicating the current state of the user 102, based on the image captured from the on-site camera 130. In the scene shown in FIG. 1, based on the image of the on-site camera 130, the guidance management server 108 detects that the user 102 is using the crutch and that the user 102 is accompanied by two adults (persons 116 and 118), and acquires user state information indicating that the “user is using the crutch and is accompanied by two adults”.

In addition, the guidance management server 108 sets, based on the user state information, the route search condition to “the number of steps in the path is small and the slope is gentle” and “the path is wide”. Then, the guidance management server 108 searches for a route (a route having a route distance equal to or less than the upper limit distance as described above) from the university 114 being the waypoint to the shopping mall 120 being the destination point, for example, a route having the smallest number of operation steps and having the maximum path width along the route, according to the set route search condition.

Then, the guidance management server 108 transmits information (route information) of the searched route to the mobile terminal 104 of the user 102. The mobile terminal 104 received the route information displays a map on the display device included in the mobile terminal according to the related art and displays the route, which is indicated by the received route information, in a superimposed manner on the map, thereby providing the route guidance to the user 102.

The guidance management server 108 can monitor the state of the user 102 using the streetlight camera 132 existing around the route or the in-vehicle camera 136 mounted on the traveling or parked vehicle 134 even when guiding the searched route from the university 114 to the shopping mall 120, for example. Thereby, the guidance management server 108 can detect the change in the state of the user 102 (for example, a case where the user 102 separates from the persons 116 and 118 and walks alone), and can acquire new user state information. The guidance management server 108 can set a new route search condition based on the acquired user state information, search for a new route according to set route search conditions, and perform continuously the route guidance on the user 102.

The route guidance system 100 having the above configuration acquires the user state information indicating the state of the user 102 who is the target of route guidance using the home camera 112 or the on-site camera 130, for example, and sets the route search condition according to the state of the user 102 indicated by the user state information. Then, the route guidance system 100 guides the user 102 to the route searched according to the set route search condition via the mobile terminal 104, for example. Thus, the route guidance system 100 can guide the user 102 to a more appropriate route according to the state of the user 102 (a body state or a presence or absence of accompanying persons).

A description will be given below with respect to configurations of the guidance management server 108 and the mobile terminal 104 forming the route guidance system 100.

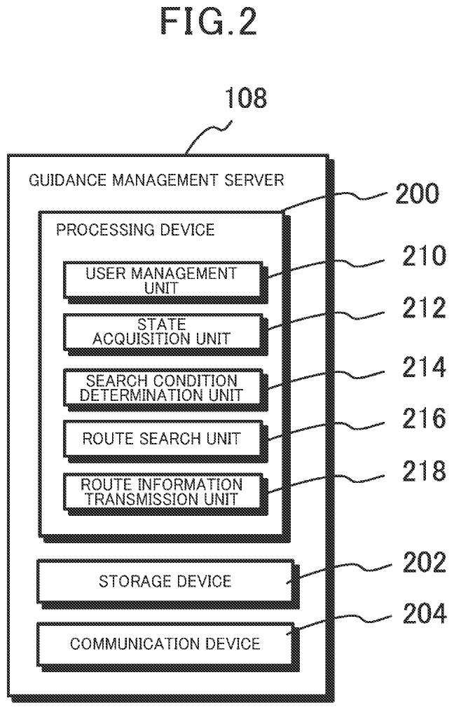

First, the configuration of the guidance management server 108 will be described. FIG. 2 is a diagram showing an example of the configuration of the guidance management server 108. The guidance management server 108 includes a processing device 200, a storage device 202, and a communication device 204. The storage device 202 is configured by, for example, a volatile and/or non-volatile semiconductor memory and/or a hard disk device. The communication device 204 is a transceiver that has an antenna and communicates with the mobile terminals 104, 138, and 140, the home camera 112, the streetlight cameras 122 and 132, the on-site camera 130, and the in-vehicle cameras 126 and 136 via the communication network 106 and performs wired communication and/or wireless communication.

The processing device 200 is a computer including a processor such as a CPU. The processing device 200 may have a configuration include a ROM (storage medium) in which a program is written and a RAM in which data is temporarily stored. The processing device 200 includes, as functional elements or functional units, a user management unit 210, a state acquisition unit 212, a search condition determination unit 214, a route search unit 216, and a route information transmission unit 218.

Such functional elements included in the processing device 200 are realized when the processing device 200 serving as the computer executes a program. The computer program can be stored in any computer-readable storage medium. Alternatively, all or part of the functional elements included in the processing device 200 may be configured by hardware including one or more electronic circuit components, respectively.

The user management unit 210 stores registration information, which is information on a person who requests to receive a route guidance service, in the storage device 202 prior to the start of the service, and registers the person as a registered user. The registration information may include a face image for authentication of the person who is the registered user, access information for communicating with the mobile terminal, and an ID code. For example, when the person who requests the route guidance service transmits a face image and access information to the guidance management server 108 via the mobile terminal, the user management unit 210 receives such information, and stores the received information obtained by adding an ID code in the storage device 202 as registration information.

Further, the user management unit 210 receives, from the mobile terminal of the registered user (hereinafter, also simply referred to as a user), a current location and a destination point (which may include a waypoint) of the registered user and a route guidance request. Hereinafter, the registered user who transmits the route guidance request is also referred to as a guidance-requesting user. In the scene shown in FIG. 1, the user 102 is a guidance-requesting user, and the mobile terminal 104 of the user 102 is a mobile terminal of the guidance-requesting user.

When receiving the route guidance request from the mobile terminal, the user management unit 210 specifies an ID code of the guidance-requesting user who transmits the route guidance request based on a communication address of the mobile terminal, and transmits an operation instruction attached with the specified ID code to the state acquisition unit 212, the route search unit 216, and the route information transmission unit 218 which will be described below.

The state acquisition unit 212 acquires user state information on a state of the guidance-requesting user in response to reception of the operation instruction from the user management unit 210. The user state information may include, for example, information regarding the body condition of the guidance-requesting user (information regarding an age, a weight, presence or absence of use of the walking assistance equipment such as a crutch or a wheelchair, and existence of a helper who pulls a hand), information regarding the composition of the accompanying or companion person (information regarding existence of a person to be assisted such as a wife, a child, a toddler, or an elderly person), information regarding an instrument or a tool carried by the guidance-requesting user (information regarding a baby carriage, a suitcase, etc.), and information regarding hand/arm states of the guidance-requesting user (information indicating whether hands are full by a kid or luggage).

The state acquisition unit 212 acquires the user state information by acquiring and processing detection information such as an image from a sensor disposed at a position where the guidance-requesting user can be caught in a field of view and/or by acquiring the information (for example, user's own weight, height, and condition) that is input in the user's own mobile terminal in advance by the guidance-requesting user. The sensor preferably includes cameras provided in the mobile terminal of the guidance-requesting user and/or the mobile terminal (for example, the mobile terminal 138 or 140 of the person 116 or 118 accompanied by the user 102 in the scene of the FIG. 1) carried by a person around the user and cameras provided in vehicles, facilities, or buildings existing around the guidance-requesting user. Such cameras are entrance cameras or cameras in elevators of convenience stores, banks, or hotels existing around the guidance-requesting user, monitoring cameras in a station, or traffic monitoring cameras installed at traffic lights and railroad crossings.

The state acquisition unit 212 can detect a guidance-requesting user and acquire user state information on the detected guidance-requesting user by, for example, performing image recognition processing based on the images captured from the cameras according to the related art to perform face image authentication of a person captured in the image.

Additionally, the state acquisition unit 212 can acquire user state information using sensors other than the cameras, for example, microphones, temperature sensors, sunshine sensors, radars, lidars, and human detection sensors (motion sensors) provided in the mobile terminals, the vehicles, the facilities, or the buildings described above. Further, the state acquisition unit 212 may acquire user state information with reference to the personal information (height, weight) stored in the mobile terminal 104 of the user 102 or personal information preserved as the registration information stored in the storage device 202 of the guidance management server 108.

Alternatively, the state acquisition unit 212 may acquire measurement information (for example, a heart rate) of a mobile device such as a wearable watch that communicates with and operates in cooperation with the mobile terminal 104, as user state information, from the mobile terminal 104. Here, when the state acquisition unit 212 acquires the information such as voice, camera image, and personal information from the mobile terminal such as the mobile terminal 104 as described above, an application program for the above acquisition can be executed in advance on such a mobile terminal according to the related art.

In order to acquire the detection information such as the image from the various sensors described above, the guidance management server 108 can store access information for accessing each of the sensors in advance in the storage device 202. Alternatively, the state acquisition unit 212 communicates with one or a plurality of other servers (not shown), which manage the various sensors described above, via the communication network 106, for example, and thus can acquire detection information from the sensors managed by the other servers, respectively, via the other servers.

Based on the user state information acquired by the state acquisition unit 212, the search condition determination unit 214 determines a route search condition (hereinafter, also simply referred to as a search condition) used when the route search unit 216 (which will be described below) searches for the route. For example, the search condition determination unit 214 associates the user state information acquired by the state acquisition unit 212 with any of predetermined state categories using a predetermined search condition table stored in the storage device 202, thereby determining a search condition according to the associated state category.

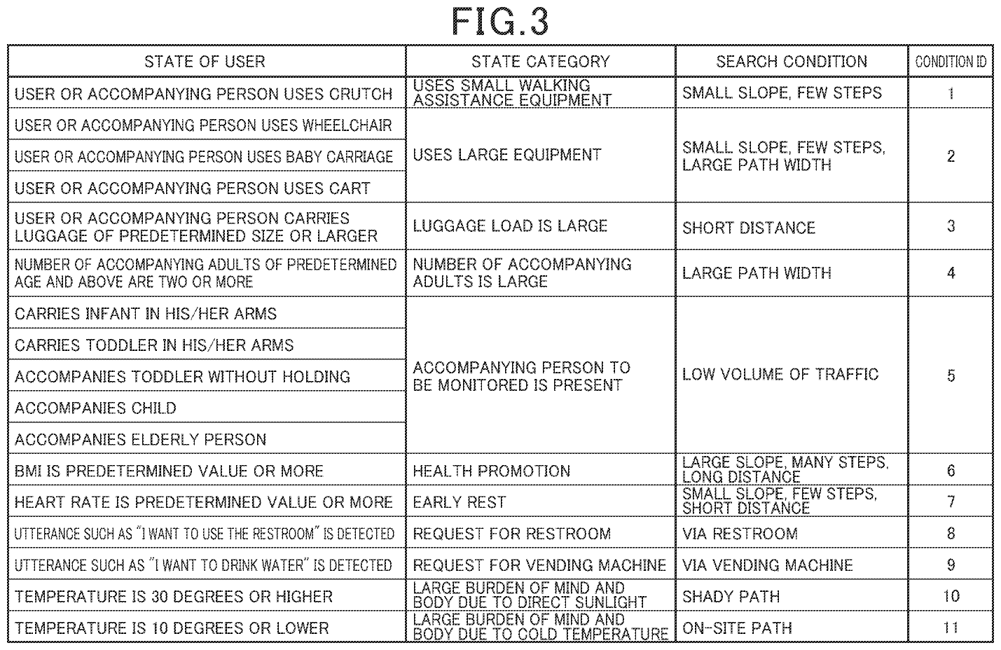

FIG. 3 is a diagram showing an example of a search condition table. A first column (leftmost column) of the search condition table shown in FIG. 3 represents user states indicated by the user state information, a second column located at a right of the first column represents state categories corresponding to the user states indicated by the first column, a third column represents search conditions to be determined according to the state categories indicated by the second column, and a fourth column represents ID numbers of countermeasure conditions.

A distinction between adults, infants, toddlers, children, and elderly persons indicated in the column of the user states can be determined from body shape characteristics and facial characteristics of the person captured in the images taken from the cameras, for example, the streetlight camera 122 and the on-site camera 130, according to the related art. Further, an BMI value indicated in the column of the user states can be calculated by the state acquisition unit 212 with reference to the weight and the height of the user 102 preserved in the personal information stored in the mobile terminal 104 of the user 102 or in the registration information stored in the storage device 202 of the guidance management server 108, for example.

Alternatively, a heart rate indicated in the column of the user states can be obtained in such a manner that the state acquisition unit 212 acquires the heart rate of the user 102 measured by the wearable watch, which is worn by the user 102 and communicates with and operates in cooperation with the mobile terminal 104, via the mobile terminal 104.

Alternatively, an utterance such as “I want to use the restroom” indicated in the column of the user states can be acquired, from a microphone 414 of the mobile terminal 104 or a sound collecting microphone (not shown) juxtaposed with the on-site camera 130, by the state acquisition unit 212.

When the state of the user indicated by the user state information corresponds to a plurality of state categories, for example, “accompanied by two adult companions of a predetermined age and above and carrying an infant in arms”, a combination condition of search conditions (for example, a search condition having a condition ID of 4 and a search condition having a condition ID of 5) corresponding to the plurality of state categories can be a final search condition. In addition, expressions of “large”, “small”, “few”, “short”, and “long” described in the columns of the search condition means a search for a route whose corresponding slope, step, and distance are “maximum”, “minimum”, “fewest”, “shortest”, and “longest” as a condition. Further, such a route can be searched from routes having a route distance equal to or less than an upper limit distance calculated by adding a predetermined margin distance to the shortest route distance to the destination point or the waypoint.

With reference to FIG. 2, the route search unit 216 uses the departure point, the waypoint, and the destination point received together with the route guidance request by the user management unit 210 and searches for the route from the departure point to the waypoint and the route from the waypoint to the destination point according to the search condition determined by the search condition determination unit 214. According to the related art, the route search performed by the route search unit 216 can be performed based on various pieces of map information in addition to the search condition. Such map information may include information on a presence or absence of road widths, steps, and stairs of sidewalks and pedestrian overpasses, a presence or absence of a width, steps, and stairs of paths in buildings, and a connection by an elevator or an escalator in addition to information on nodes and links representing road connections and information on buildings.

Additionally, the route search unit 216 can also search for the route using the traffic volume information stored in the storage device 202, for example. The traffic volume information may be a traffic volume of vehicles and people per a predetermined current time calculated by the guidance management server 108 or other servers, according to the related art, based on images acquired from a streetlight camera or a camera in a building or an average value (average traffic volume) of such a traffic volume for a predetermined period (for example, per day for each day of the week).

The route information transmission unit 218 transmits the route information indicating the route searched by the route search unit 216 to the mobile terminal (for example, the mobile terminal 104 of the user 102) of the guidance-requesting user who transmits the route guidance request.

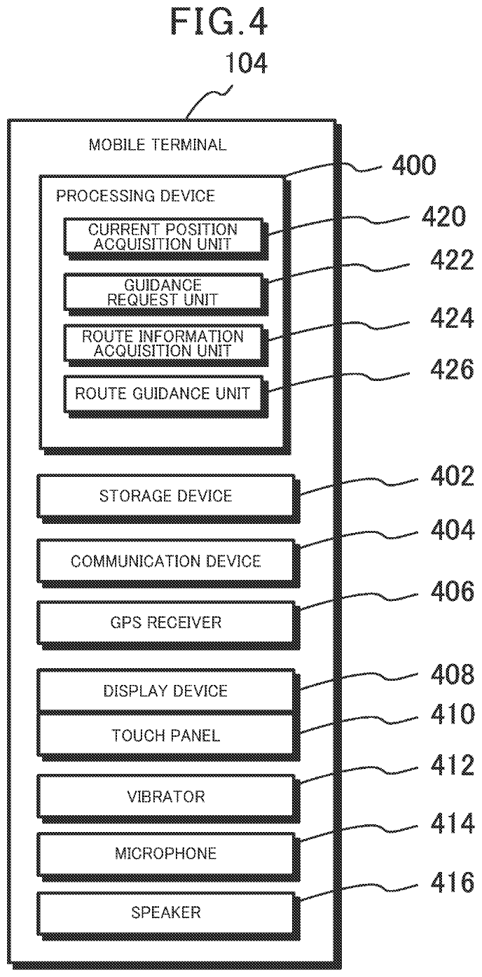

Next, a configuration of the mobile terminal 104 forming the route guidance system 100 will be described. FIG. 4 is a diagram showing an example of the configuration of the mobile terminal 104. The mobile terminal 104 is, for example, a smartphone, and includes a processing device 400, a storage device 402, a communication device 404, and a GPS receiver 406. Further, the mobile terminal 104 includes a display device 408, a touch panel 410, a vibrator 412, a microphone 414, and a speaker 416.

The storage device 402 is configured by a volatile and/or non-volatile semiconductor memory, for example. The communication device 404 is a transceiver that has an antenna and communicates with the guidance management server 108 and the other mobile terminals 138 and 140 via the communication network 106 and performs wireless communication. The GPS receiver 406 is a wireless receiver that receives GPS waves from a GPS satellite. Further, the display device 408 is, for example, a liquid crystal display device (LCD), and the touch panel 410 is disposed on a screen of the display device 408. The vibrator 412 is a motor that causes a housing of the mobile terminal 104 to vibrate.

The processing device 400 is a computer including a processor such as a CPU. The processing device 400 may have a configuration include a ROM (storage medium) in which a program is written and a RAM in which data is temporarily stored. The processing device 400 includes, as functional elements or functional units, a current position acquisition unit 420, a guidance request unit 422, a route information acquisition unit 424, and a route guidance unit 426.

Such functional elements included in the processing device 400 are realized when the processing device 400 serving as the computer executes a computer program. The computer program can be stored in any computer-readable storage medium. Alternatively, all or part of the functional elements included in the processing device 400 may be configured by hardware including one or more electronic circuit components, respectively.

In the present embodiment, the functional elements are realized when the processing device 400 executes an application program which is a terminal program.

According to the related art, the current position acquisition unit 420 acquires information indicating the current position of the mobile terminal 104 based on the GPS wave received by the GPS receiver 406 included in the mobile terminal 104. The processing device 400 transmits the current position information acquired by the current position acquisition unit 420 to the guidance management server 108 in response to an instruction of the guidance management server 108.

According to the related art, the guidance request unit 422 acquires information on a departure point, a waypoint, and a destination point input by the user 102, who is an owner of the mobile terminal 104, via the touch panel 410 or the microphone 414, for example.

In response to the instruction input by the user 102 via the touch panel 410, the guidance request unit 422 further transmits the information on the input departure point, waypoint, and destination point and the route guidance request for requesting the route guidance from the departure point to the destination point, to the guidance management server 108.

The route information acquisition unit 424 receives the route information on the route from the departure point to the destination point, from the guidance management server 108.

The route guidance unit 426 guides the user to the route (guidance route) searched by the route search unit 216 of the guidance management server 108. Specifically, based on the route information received and acquired from the guidance management server 108 by the route information acquisition unit 424, the route guidance unit 426 displays a map on the display device 408 and displays the route, which is indicated by the route information, on the displayed map according to the related art. Further, the route guidance unit 426 specifies the current position of the mobile terminal 104 indicated by the position information acquired by the current position acquisition unit 420 on the map, and displays the specified position on the display device 408 in a superimposed manner on the map.

Additionally, when the current position approaches places where the user 102 is likely to mistakenly take a wrong route, such as branch points of a road or a path on the map in a case where the current position moves as the user 102 moves, the route guidance unit 426 can give an instruction to the user 102 via the vibrator 412 and/or the speaker 416 such that the user 102 turns left or right along the guidance route.

In the route guidance system 100 including the guidance management server 108 and the mobile terminal 104, for example, when the route guidance request is transmitted to the guidance management server 108 from the mobile terminal 104 of the user 102 who is the guidance-requesting user, the state acquisition unit 212 of the guidance management server 108 acquires the user state information indicating the state of the user 102 from the camera (for example, the home camera 112 or the streetlight camera 122) existing around the mobile terminal 104. Then, the search condition determination unit 214 of the guidance management server 108 determines the search condition of the route based on the user's state indicated by the user state information, searches for the route to the destination point using the route search unit 216 based on the determined search condition, and guides the user 102 to the searched route using the route guidance unit 426 of the mobile terminal 104.

Thus, the route guidance system 100 can guide the user 102 to a more appropriate route according to the state of the user 102, for example, the body state and the possession of the luggage.

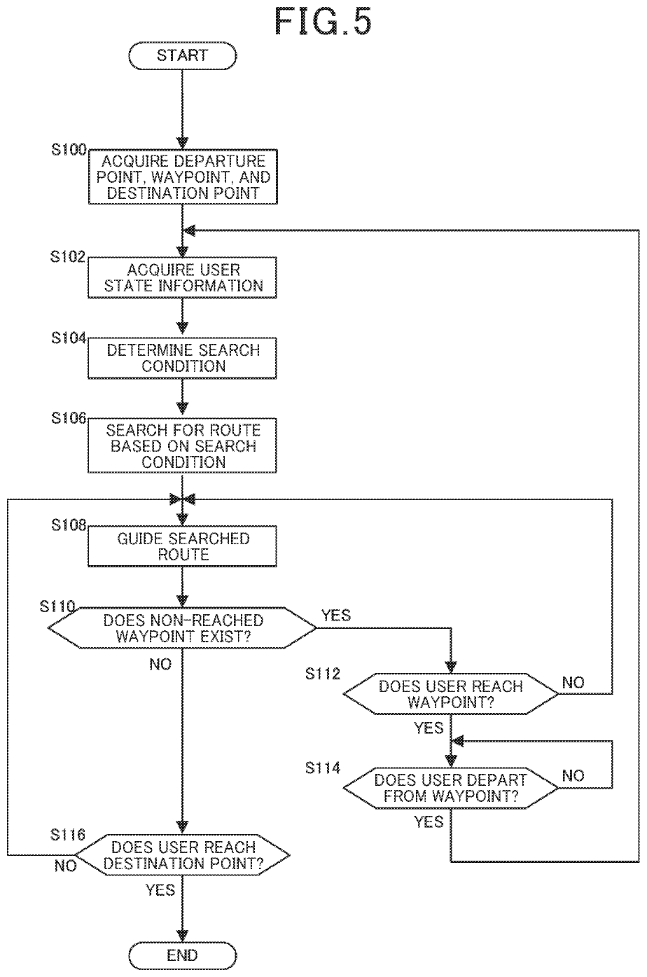

Next, an operation of the route guidance system 100 will be described. FIG. 5 is a flowchart showing an operation procedure of the route guidance system 100. Such a procedure starts when the user 102 inputs at least the departure point and the destination point to the mobile terminal 104 forming the route guidance system 100.

When the procedure starts, the guidance request unit 422 of the mobile terminal 104 acquires the departure point, the waypoint (the same shall apply when being input), and the destination point input by the user 102 (S100). The mobile terminal 104 transmits the information indicating the acquired departure point, waypoint, and destination point and the route guidance request to the guidance management server 108 forming the route guidance system 100.

Next, the guidance management server 108 acquires the user state information indicating the current state of the user 102, who is the guidance-requesting user, using the state acquisition unit 212, based on the images captured from the home camera 112 of the home 110 and the streetlight camera 122 existing around the current position of the mobile terminal 104 (S102).

Subsequently, the search condition determination unit 214 of the guidance management server 108 determines the search condition for searching the route based on the acquired user state information (S104).

Next, the route search unit 216 of the guidance management server 108 searches for the route from the acquired departure point to the destination point through the waypoint, based on the determined search condition (S106). The guidance management server 108 transmits the route information, which is the information on the searched route, to the mobile terminal 104 using the route information transmission unit 218. The mobile terminal 104 receives and acquires the transmitted route information using the route information acquisition unit 424.

Based on the acquired route information, the route guidance unit 426 of the mobile terminal 104 displays, on the display device 408, the searched route and the current position of the mobile terminal 104 acquired by the current position acquisition unit 420, and performs the route guidance (S108). Next, the route guidance unit 426 determines whether a non-reached waypoint exists still (S110). When the non-reached waypoint exists (S110, YES), the route guidance unit 426 determines that the user reaches the waypoint (S112). Then, when the user does not reach the waypoint (S112, NO), the process returns to step S108 and the route guidance unit 426 continues the route guidance.

On the other hand, when the user reaches the waypoint (S112, YES), the route guidance unit 426 determines, based on the current position information of the mobile terminal 104 acquired by the current position acquisition unit 420, whether the mobile terminal 104 starts moving from the waypoint, that is, whether the user 102 departs from the waypoint (S114).

When the user 102 does not depart from the waypoint (S114, NO), the process returns to step S114 and the route guidance unit 426 waits for the user 102 to depart from the waypoint. On the other hand, when the user 102 departs from the waypoint, that is, when the mobile terminal 104 starts moving from the waypoint (S114, YES), the route guidance unit 426 transmits a re-search request to the guidance management server 108, and then the process returns to step S102. The guidance management server 108, which has received the re-search request, acquires new user state information using the state acquisition unit 212 in step S102, and steps after step S104 are repeated.

On the other hand, when the non-reached waypoint does not exist in step S110 (including when no waypoint is input) (S110, NO), the route guidance unit 426 determines whether the user reaches the destination point (S116). Then, when the user does not reach the destination point (S116, NO), the process returns to step S108 and the route guidance unit 426 continues the route guidance. On the other hand, when the user reaches the destination point (S116, YES), the route guidance unit 426 ends the procedure.

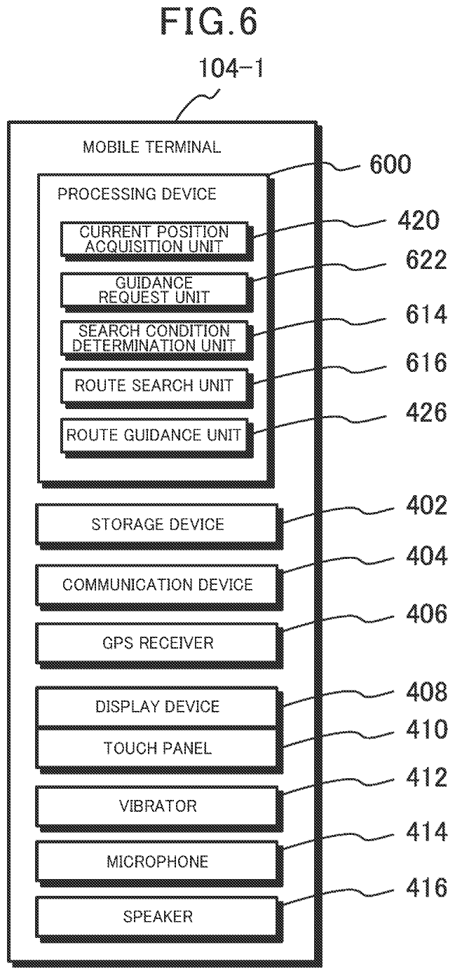

The configurations of the guidance management server 108 and the mobile terminal 104 forming the route guidance system 100 are not limited to the configurations shown in FIGS. 2 and 4. For example, the search condition determination unit 214 and the route search unit 216 may be provided in the mobile terminal 104 instead of the guidance management server 108. FIG. 6 is a diagram showing a configuration of a mobile terminal 104-1, which is a modified example of the mobile terminal 104. Here, components of the mobile terminal 104-1 shown in FIG. 6 equal to the components of the mobile terminal 104 shown in FIG. 4 are denoted by the same reference numerals as those shown in FIG. 4, and will be quoted with reference to the description of FIG. 4.

The mobile terminal 104-1 has the same configuration as the mobile terminal 104 except for including a processing device 600 instead of the processing device 400. Like the processing device 400, the processing device 600 is a computer including a CPU or the like. However, unlike the processing device 400, the processing device 600 includes a guidance request unit 622 instead of the guidance request unit 422, and includes a search condition determination unit 614 and a route search unit 616 having the same configuration as the search condition determination unit 214 and the route search unit 216 of the guidance management server 108 shown in FIG. 2 without including the route information acquisition unit 424.

Similarly to the current position acquisition unit 420 and the route guidance unit 426, the guidance request unit 622, the search condition determination unit 614, and the route search unit 616 are functional elements or functional units to be realized when the processing device 600 serving as the computer executes a terminal program, for example, an application program.

The guidance request unit 622 has the same configuration as the guidance request unit 422, but in response to an instruction input by the user 102 via the touch panel 410, transmits the information on the input departure point, waypoint (in the case of being input), and destination point to the route search unit 616, and transmits the state information request to the guidance management server 108. The guidance management server 108, which has received the state information, can acquire the user state information of the user 102 using the state acquisition unit 212, and transmit the acquired information to the mobile terminal 104-1.

The search condition determination unit 614 has the same configuration as the search condition determination unit 214, receives the user state information transmitted from the guidance management server 108, and determines a search condition using the search condition table shown in FIG. 3, based on the received user state information.

Similarly to the route search unit 216, the route search unit 616 searches for a route from the departure point to the destination point according to the search condition determined by the search condition determination unit 614, and sends route information on the searched route to the route guidance unit 426.

In the mobile terminal 104-1 having the above-described configuration, the guidance management server 108 only needs to acquire the user state information of the user 102 and transmit the acquired information to the mobile terminal 104-1, so that the processing load of the guidance management server 108 is reduced. Further, since the route search is performed on the mobile terminal 104-1, it is possible to easily customize the route search operation by adding the search condition according to preference of the user 102, for example.

### Second Embodiment

A second embodiment of the present invention will be described below. A route guidance system according to the second embodiment guides a user, who is a user of a vehicle, to a parking spot of the vehicle.

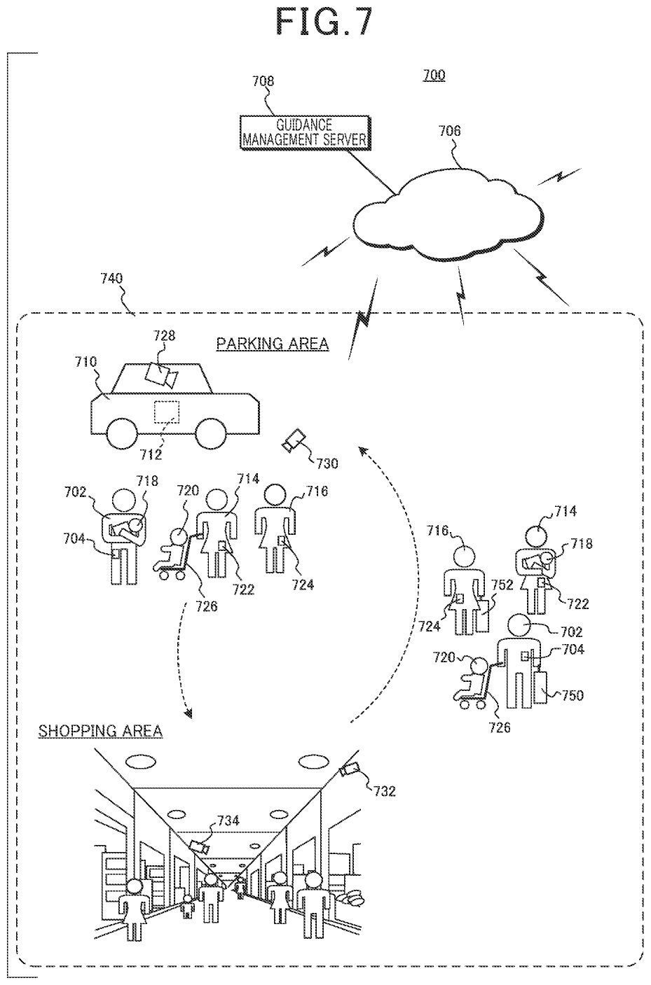

FIG. 7 is a view showing an example of a scene in which a route guidance system 700 according to the second embodiment is used. The route guidance system 700 includes, for example, a mobile terminal 704 which is a terminal device possessed by the user 702, an in-vehicle guidance device 712 provided in a vehicle 710 to be used by the user 702, and a guidance management server 708. The mobile terminal 704 and the in-vehicle guidance device 712 are communicably connected to the guidance management server 708 via a communication network 706. The communication network 706 can be an open network such as Internet. The mobile terminal 704 is a multifunctional mobile terminal such as a smartphone.

The user 702 is a vehicle user who uses the vehicle 710, and is a registered user who is registered in advance in the guidance management server 708 as a user who receives a route guidance service. When the user 702 parks the vehicle 710, the route guidance system 700 acquires a parking spot of the vehicle 710, and acquires an image of the user 702, who gets off the vehicle 710, from an in-vehicle camera 728 provided in the vehicle 710. Further, the guidance management server 708 acquires, from the acquired image, user state information regarding a state of the user 702.

Then, when the user 702 finishes business and returns to the vehicle 710, the route guidance system 700 determines a route search condition based on the acquired user state information, for example. In addition, the route guidance system 700 searches for a route to the parking spot of the vehicle 710 based on the determined route search condition, and guides the user 702 to the searched route via the mobile terminal 704.

For example, in the scene shown in FIG. 7, the user 702 is shopping at a shopping mall 740 along with persons 714, 716, 718, and 720 using the vehicle 710. The persons 714 and 716 are adults, for example, a wife and a sister of the user 702. The persons 718 and 720 are kids of the user 702, that is, toddlers or infants.

The user 702 parks the vehicle 710 in a parking area of the shopping mall 740, gets off the vehicle along with the persons 714, 716, 718, and 720, and moves to a shopping area of the shopping mall 740. The in-vehicle guidance device 712 transmits a current position as a parking spot of the vehicle 710 to the guidance management server 708 when the vehicle 710 is parked. The guidance management server 708, which has received the parking spot, acquires an image of the user 702, who gets off the vehicle 710, from the in-vehicle camera 728 of the vehicle 710 and an on-site camera 730 installed in the shopping mall 740, and acquires user state information indicating the state of the user 702 based on the acquired image. Here, the guidance management server 708 can acquire images of the in-vehicle camera 728 and the on-site camera 730 from a security server (not shown) set in each of the in-vehicle guidance device 712 and the shopping mall 740.

The user state information acquired by the guidance management server 708 is equal to the user state information acquired by the guidance management server 108 according to the first embodiment described above. In the scene shown in FIG. 7, the guidance management server 708 acquires user state information indicating that the user 702 is accompanied by the persons 714, 716, 718, and 720, the user 702 is holding the person 718 who is an infant, and the person 714 is being pushing a baby carriage 726 on which the person 720 who is a toddler sits.

Thereafter, the user 702 finishes the business such as shopping in the shopping area together with the persons 714, 716, 718, and 720, and uses the mobile terminal 704 to transmit a route guidance request for requesting a route to the parking spot of the vehicle 710 to the guidance management server 708. Based on the acquired user state information, the guidance management server 708, which has received the route guidance request, determines a search condition of the route, similarly to the guidance management server 108 according to the first embodiment.

Then, the guidance management server 708 searches for the route to the parking spot of the vehicle 710 according to the determined search condition, and executes guidance of the searched route via the mobile terminal 704.

Similarly to the route guidance system 100 according to the first embodiment, the route guidance system 700 sets a route search condition based on the user state information indicating the state of the user 702 who is the target of the route guidance, and guides the user 702 to the route searched according to the set route search condition. Thereby, the route guidance system 700 can guide the user 702 to a more appropriate route according to the state of the user 702.

When the mobile terminal 704 is within a range of a predetermined distance (for example, 500 meters) from the parking spot even in a case where the guidance management server 708 does not receive the route guidance request from the mobile terminal 704, the route guidance system 700 can allow the mobile terminal 704 to perform the route guidance to the parking spot, using the search condition based on the user state information.

In the route guidance system 700, when the mobile terminal 704 approaches within a range of a predetermined distance (for example, 10 meters) from the parking spot of the vehicle 710, the guidance management server 708 may instruct the in-vehicle guidance device 712 to operate a horn or sidelights of the vehicle 710 and may audibly or visually notify the user 702 of the position of the vehicle 710.

In the route guidance system 700, when the mobile terminal 704 approaches within a range of a predetermined distance (for example, several meters) from the parking spot of the vehicle 710, the guidance management server 708 can instruct the in-vehicle guidance device 712 to open a proper door of the vehicle 710 according to the state of the user 702 and/or the accompanying person indicated by the user state information (including a state of possession of luggage or a state of use of a tool such as a baby carriage).

A description will be given below with respect to configurations of the guidance management server 708, the mobile terminal 704, and the in-vehicle guidance device 712 which are included in the route guidance system 700.

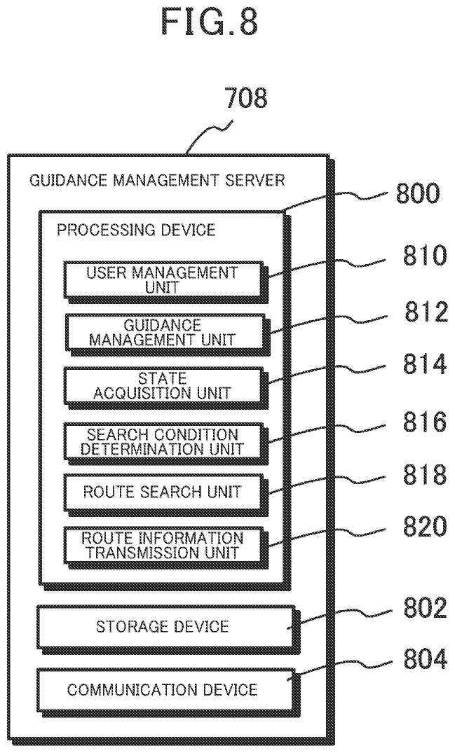

First, the configuration of the guidance management server 708 will be described. FIG. 8 is a diagram showing an example of the configuration of the guidance management server 708. The guidance management server 708 includes a processing device 800, a storage device 802, and a communication device 804. The storage device 802 is configured by, for example, a volatile and/or non-volatile semiconductor memory and/or a hard disk device. The communication device 804 is a transceiver that has an antenna and communicates with the mobile terminals 704, 722, and 724, the in-vehicle guidance device 712, and the on-site cameras 730, 732, and 734 (or a security server (not shown) configured to control operation of these cameras) via the communication network 706 and performs wired communication and/or wireless communication.

The processing device 800 is a computer including a processor such as a CPU. The processing device 800 may have a configuration include a ROM (storage medium) in which a program is written and a RAM in which data is temporarily stored. The processing device 800 includes, as functional elements or functional units, a user management unit 810, a guidance management unit 812, a state acquisition unit 814, a search condition determination unit 816, a route search unit 818, and a route information transmission unit 820.

Such functional elements included in the processing device 800 are realized when the processing device 800 serving as the computer executes a program. The computer program can be stored in any computer-readable storage medium. Alternatively, all or part of the functional elements included in the processing device 800 may be configured by hardware including one or more electronic circuit components, respectively.

The user management unit 810 stores registration information, which is information on a person who requests to receive a route guidance service, in the storage device 802 prior to the start of the service, and registers the person as a registered user. The registration information may include a face image for authentication and an ID code of the person who is the registered user, access information for communicating with the mobile terminal, and access information for communicating with the vehicle used by the registered user. Further, the registration information may include face images of family of the registered user and access information of the mobile terminal.

For example, when a person who requests a route guidance service transmits face images of himself/herself and his/her family and access information of the mobile terminal to the guidance management server 708 via the mobile terminal, the user management unit 810 receives such information, and stores the received information obtained by adding an ID code in the storage device 802 as registration information. In the scene shown in FIG. 7, the user 702 is a registered user, and registration information of the user 702 is stored in the storage device 802. Hereinafter, the configuration of the route guidance system 700 will be described in relation to the user 702 who is the registered user and the mobile terminal 704 and the vehicle 710 of the user.

When receiving parking spot information on the parking spot of the vehicle 710 from the in-vehicle guidance device 712 of the vehicle 710 used by the user 702 who is the registered user (hereinafter, also simply referred to as a user), the guidance management unit 812 allows the storage device 802 to store the received parking spot information and instructs the state acquisition unit 814 to perform an operation which will be described below.

Further, when the parking spot information is received, the guidance management unit 812 acquires a current position of the mobile terminal 704 of the user 702, who is the corresponding registered user, at predetermined time intervals. When the route guidance request is received from the mobile terminal 704 of the user 702 and/or when the mobile terminal 704 of the user 702 is within a range of a predetermined guidance start distance (for example, 500 meters) from the position indicated by the received parking spot information, the guidance management unit 812 instructs the search condition determination unit 816, the route search unit 818, the route information transmission unit 820 to perform an operation, and starts to guide the user 702 to the route to the parking spot of the vehicle 710.

Further, when reception confirmation non-arrival notification (which will be described below) is received from the route information transmission unit 820, the guidance management unit 812 sends notification indicating that “the route guidance is possible to the parking spot of the vehicle 710” to the mobile terminal 704 of the user 702. Alternatively, or additionally, when the reception confirmation non-arrival notification (which will be described below) is received from the route information transmission unit 820, the guidance management unit 812 can transmit traveling instructions to turn right, turn left, and go straight with movement of the mobile terminal 704, to the mobile terminal 704, such that the user 702 is guided along the route searched by the route search unit 818. The “notification that the route guidance is possible” and the traveling instructions can be transmitted in a form of a so-called push notification to a mobile terminal such as a smartphone and can be output from the mobile terminal 704.

Further, when the mobile terminal 704 of the user 702 is within a range of a predetermined direct notification distance (for example, 10 meters) from the position indicated by the received parking spot information, the guidance management unit 812 transmits an alarm instruction to the in-vehicle guidance device 712 to cause the vehicle 710 to perform a sound and/or lighting alarm operation. As will be described below, the sound and/or lighting alarm operation may include sounding of the horn or turning-on or flickering of head lamps and sidelights in the vehicle 710.

Further, when the mobile terminal 704 of the user 702 is within a range of a predetermined proximity distance (for example, 5 meters) from the position indicated by the received parking spot information, the guidance management unit 812 transmits the user state information on the user 702 and a door operation instruction to the in-vehicle guidance device 712. The in-vehicle guidance device 712 opens, based on the user state information, the vehicle door suitable for riding of the user 702 and the accompanying person (which will be described below).

Further, when it is determined, based on the user state information acquired by the state acquisition unit 814, that hands of the user 702 are full and thus the user 702 can hardly receive the route guidance from the mobile terminal 704, the guidance management unit 812 can guide the user 702 to the route searched by the route search unit 818 via the mobile terminal 722 or 724 of any person 714 or 716 accompanied by the user 702.

In such a case, the guidance management unit 812 can acquire access information for communicating with the mobile terminal 722 or 724 of the person 714 or 716 with reference to the face image of the person 714 or 716 registered in the registration information of the user 702 as family information of the user 702 and the access information of the mobile terminal 722 or 724, for example. Specifically, the guidance management unit 812 can specify that the person accompanied by the user 702 is the person 714 or 716, using the face image of the person 714 or 716, and acquire the access information of the mobile terminal 722 or 724 of the specified person 714 or 716 from the registration information.

In the case described above, the route guidance can be performed by the mobile terminal 722 or 724 of the accompanying person 714 or 716 when the guidance management unit 812 transmits the above-described traveling instruction to the mobile terminal 722 or 724 by the push notification.

Alternatively, in the mobile terminal 722 or 724, when the route information acquisition unit 926 and the route guidance unit 928 are realized by execution of a program for terminal as in the mobile terminal 704 which will be described below, the route is displayed on a display device of the mobile terminal 722 or 724 as in an operation of the mobile terminal 704 which will be described below, and thus the route guidance can be performed by the mobile terminal 722 or 724.

The state acquisition unit 814 acquires user state information regarding at least the state of the user 702 getting off the vehicle 710 in response to reception of the operation instruction from the guidance management unit 812. The reason for acquiring the user state information of the user 702 is to reliably acquire a use state, as user state information, of the baby carriage or the wheelchair to be used after the user gets off the vehicle 710.

Similarly to the first embodiment, the user state information may include, for example, information regarding the body condition of the user 702 (information regarding an age, a weight, presence or absence of use of the walking assistance equipment such as a crutch or a wheelchair, and existence of a helper who pulls a hand), information regarding the composition of the accompanying or companion person of the user 702 (information regarding existence of a person to be assisted such as a wife, a child, a toddler, or an elderly person), information regarding an instrument or a tool carried by the user 702 and the accompanying person (that is, persons 714, 716, 718, or 720) (information regarding a baby carriage, a suitcase, etc.), and information regarding hand/arm states of the user 702 and the accompanying person (information indicating whether hands are full by a kid or luggage).

The state acquisition unit 814 acquires the user state information by acquiring and processing detection information such as an image from a sensor disposed at a position where the user 702 can be caught in a field of view and/or by acquiring the information (for example, own weight, height, and condition) that is input in the own mobile terminal 704 in advance by the user 702. The sensor preferably includes not only the in-vehicle camera 728 of the vehicle 710 but also cameras provided in the mobile terminal 704 of the user 702 and/or the mobile terminal (for example, the mobile terminal 722 or 724 of the person 714 or 716 accompanied by the user 702 in the scene of the FIG. 7) carried by a person around the user and/or cameras (for example, on-site cameras 730, 732, and 734) provided in vehicles, facilities, or buildings existing around the user 702. Additionally, the state acquisition unit 814 can also acquire user state information using sensors, for example, radars, lidars, or human detection sensors provided in mobile terminals, vehicles, facilities, and buildings, other than the camera.

The state acquisition unit 814 can detect the user 702 and acquire user state information on the detected user 702 by, for example, performing image recognition processing based on the images captured from the in-vehicle camera 728 according to the related art to perform face image authentication of a person captured in the image.

In order to acquire the detection information such as the image from the sensors described above, the guidance management server 708 can store access information for accessing each of the sensors in advance in the storage device 802. Alternatively, the state acquisition unit 814 communicates with one or a plurality of other servers (not shown), which manage the various sensors described above, via the communication network 706, for example, and thus can acquire detection information from the sensors managed by the other servers, respectively, via the other servers. For example, the guidance management server 708 may acquire images from the on-site cameras 730, 732, and 734 via a security server (not shown) of the shopping mall 740 that centrally manages these on-site cameras.

Based on the user state information acquired by the state acquisition unit 814, the search condition determination unit 816 determines a search condition used when the route search unit 818 (which will be described below) searches for the route. Similarly to the search condition determination unit 214 of the guidance management server 108 according to the first embodiment, the search condition determination unit 816 can use the search condition table as shown in FIG. 3 to determine a search condition from the user state information acquired by the state acquisition unit 814.

The route search unit 818 searches for a route from the current position of the mobile terminal 704 to the destination point according to the search condition determined by the search condition determination unit 816, with the parking spot of the vehicle 710 as a destination point. As in the route search unit 216 of the guidance management server 108 according to the first embodiment, the route search performed by the route search unit 818 can be performed based on various pieces of map information according to the related art except for using the search condition. Additionally, the route search unit 216 can also search for the route using the traffic volume information (the traffic volume of vehicles and people per a predetermined time or the average value of such a traffic volume for a period) stored by the storage device 202, for example, as in the route search unit 216.

The route information transmission unit 820 transmits the route information indicating the route searched by the route search unit 818 to the mobile terminal 704 of the user 702. At that time, the route information transmission unit 820 confirms that the route information is acquired by the route information acquisition unit 926 of the mobile terminal 704 by receiving a reception confirmation response from the mobile terminal 704. When not receiving the reception confirmation response within a predetermined time after the route information is transmitted, the route information transmission unit 820 sends a reception confirmation non-arrival notification to the guidance management unit 812. Thus, the guidance management unit 812 recognizes that a program for terminal is not executed in the mobile terminal 704, the program for terminal being used to realize the route information acquisition unit 926.

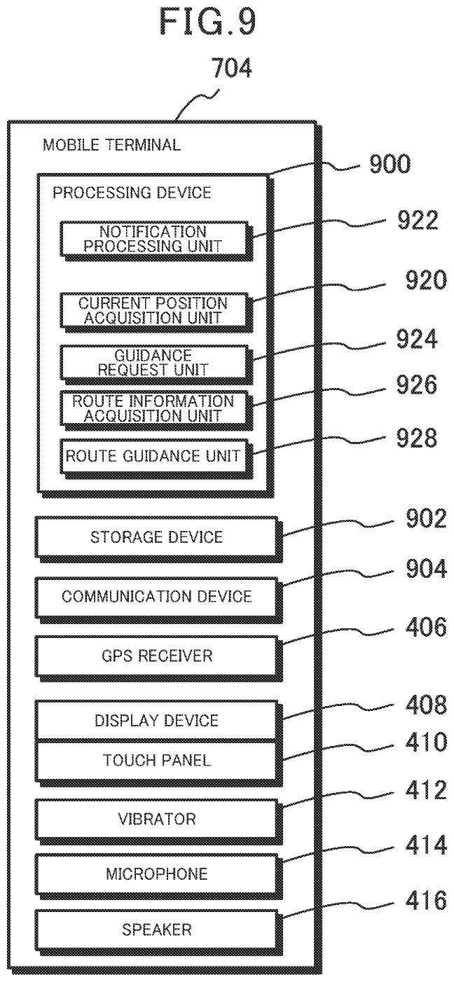

Next, a configuration of the mobile terminal 704 of the user 702 forming the route guidance system 700 will be described. FIG. 9 is a diagram showing an example of the configuration of the mobile terminal 704. Components of the mobile terminal shown in FIG. 9 equal to the components of the mobile terminal 104 shown in FIG. 4 are denoted by the same reference numerals as those shown in FIG. 4, and will be quoted with reference to the description of FIG. 4.

The mobile terminal 704 is, for example, a smartphone, and includes a processing device 900, a storage device 902, a communication device 904, and a GPS receiver 406. Further, the mobile terminal 704 includes a display device 408, a touch panel 410, a vibrator 412, a microphone 414, and a speaker 416.

The storage device 902 is configured by a volatile and/or non-volatile semiconductor memory, for example. The communication device 904 is a wireless transceiver that has an antenna and communicates with the guidance management server 708 and other mobile terminals 722 and 724 via the communication network 706 and performs wireless communication. The GPS receiver 406 is a wireless receiver that receives GPS waves from a GPS satellite.

The processing device 900 is a computer including a processor such as a CPU. The processing device 900 may have a configuration include a ROM (storage medium) in which a program is written and a RAM in which data is temporarily stored. The processing device 900 includes, as functional elements or functional units, a current position acquisition unit 920, a notification processing unit 922, a guidance request unit 924, a route information acquisition unit 926, and a route guidance unit 928.

Such functional elements included in the processing device 900 are realized when the processing device 900 serving as the computer executes a computer program. The computer program can be stored in any computer-readable storage medium. Alternatively, all or part of the functional elements included in the processing device 900 may be configured by hardware including one or more electronic circuit components, respectively.

In the present embodiment, the notification processing unit 922 is realized as a part of an OS function when the processing device 900 executes an operating system (OS) program, for example. Further, the current position acquisition unit 920, the guidance request unit 924, the route information acquisition unit 926, and the route guidance unit 928 are realized when the processing device 900 executes an application program, which is a program for terminal, on the OS.

The application program can be executed in advance on the mobile terminal 704 when the user 702 parks the vehicle 710 or gets off the vehicle 710, for example. Alternatively, the application program can be executed when the user 702 inputs an instruction using the touch panel 410 according to the “notification indicating that the route guidance is possible” received by the mobile terminal 704 and displayed on the display device 408, the notification being transmitted as a push notification by the guidance management unit 812 of the guidance management server 708 described above.

According to the related art, the current position acquisition unit 920 acquires current position information indicating the current position of the mobile terminal 704 based on the GPS wave received by the GPS receiver 406 included in the mobile terminal 704. The processing device 900 transmits the current position information acquired by the current position acquisition unit 920 to the guidance management server 708 in response to an instruction of the guidance management server 708.

According to the related art, the notification processing unit 922 processes the push notification transmitted from the guidance management server 708. The push notification may include not only display information such as a text message to be displayed on the display device 408 but also sound information on sound or voice to be output by the speaker 416, and vibration information on vibration to be generated by the vibrator 412. Based on the push notification received by the communication device 904, the notification processing unit 922 displays, on the display device 408, the text or image indicated by the display information included in the push notification, and outputs the sound or voice indicated by the sound information from the speaker 416, and/or outputs the vibration indicated by the vibration information using the vibrator 412.

In response to the instruction input by the user 702 via the touch panel 410, the guidance request unit 924 transmits the route guidance request for requesting the route guidance to the parking spot of the vehicle 710 to the guidance management server 708.

The route information acquisition unit 926 receives the route information on the route to the parking spot of the vehicle 710, which is the destination point, from the guidance management server 708.

Similarly to the route guidance unit 426 of the mobile terminal 104 according to the first embodiment, the route guidance unit 928 guides the user to the route (guidance route) searched by the route search unit 818 of the guidance management server 708. Specifically, based on the route information received by the route information acquisition unit 926, the route guidance unit 928 displays a map on the display device 408 and displays the route, which is indicated by the route information, on the displayed map according to the related art. Further, the route guidance unit 928 specifies the current position of the mobile terminal 704 indicated by the position information acquired by the current position acquisition unit 920 on the map, and displays the specified position on the display device 408 in a superimposed manner on the map.

Additionally, when the current position approaches places where the user 702 is likely to mistakenly take a wrong route, such as branch points of a road or a path on the map in a case where the current position moves as the user 702 moves, the route guidance unit 928 can give an instruction to the user 702 via the vibrator 412 and/or the speaker 416 such that the user 702 turns left or right along the guidance route.

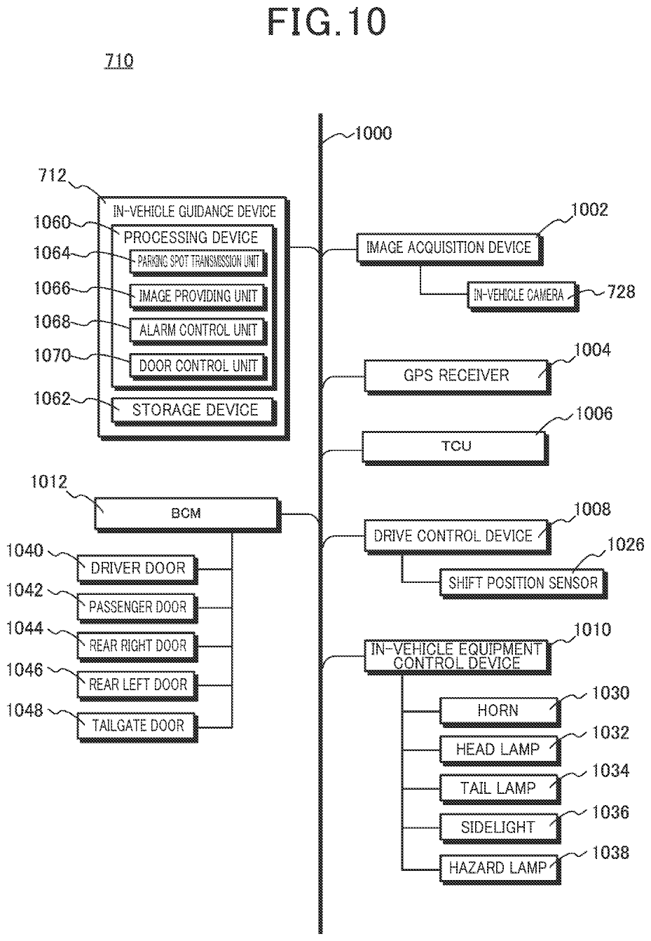

A description will be given below with respect to a configuration of the in-vehicle guidance device 712 of the vehicle 710 forming the route guidance system 700. FIG. 10 is a diagram showing an example of the configuration of the in-vehicle guidance device 712.

In the present embodiment, the in-vehicle guidance device 712 is an in-vehicle electronic control device (ECU). The in-vehicle guidance device 712 is communicably connected to another in-vehicle ECU via an in-vehicle network bus 1000. Such another in-vehicle ECU may include an image acquisition device 1002, a GPS receiver 1004, a TCU (telematics control unit) 1006, a drive control device 1008, an in-vehicle equipment control device 1010, and a BCM (body control module) 1012. The in-vehicle network bus 1000 is a CAN (Control Area Network) bus that performs communication in conformity with a CAN communication standard.

The image acquisition device 1002 includes a processing device (not shown) such as a CPU to control an operation of the in-vehicle camera 728, and acquires an image captured by the in-vehicle camera 728. The image acquisition device 1002 transmits the acquired image to another in-vehicle device via the in-vehicle network bus 1000. The in-vehicle camera 728 may include one or a plurality of vehicle exterior cameras that capture images of external environments of front, rear, left, and right sides of the vehicle 710, for example. Additionally, the in-vehicle camera 728 may also include a vehicle interior camera that captures an image of an interior of the vehicle 710.

The GPS receiver 1004 includes a wireless receiver (not shown) that receives GPS waves from GPS satellites and a processing device (not shown) such as a CPU, and calculates current position information indicating the current position of the vehicle 710 from the received GPS waves. Further, the GPS receiver 1004 transmits the calculated current position information to another in-vehicle device via the in-vehicle network bus 1000.

The TCU 1006 includes a wireless transceiver (not shown) that has an antenna and communicates with the guidance management server 708 or the mobile terminal via the communication network 706 and a processing device (not shown) such as a CPU that controls an operation of the wireless transceiver.

The drive control device 1008 controls an operation of a motor (or an engine; not shown) that drives the vehicle 710 and an operation of a gearbox (not shown) to allow the vehicle 710 to travel, and sets the vehicle 710 to a parked state according to a shift position of a shift lever of the gearbox. In the present embodiment, the drive control device 1008 detects a shift position using a shift position sensor 1026 provided in the gearbox, and transmits information indicating whether the vehicle 710 is set to the parked state, to another device via the in-vehicle network bus 1000.

The in-vehicle equipment control device 1010 controls operations of lighting devices, for example, head lamps 1032, tail lamps 1034, sidelights 1036, hazard lamps 1038 in addition to a horn (a klaxon) 1030 of the vehicle 710.

The BCM 1012 includes a processing device (not shown) such as a CPU to control actuators provided in a driver door 1040, a passenger door 1042, a rear right door 1044, a rear left door 1046, and a tailgate door (a door of a trunk (cargo bed)) 1048 which are doors of the vehicle 710, and controls opening operation (door opening operation) of these doors.

The in-vehicle guidance device 712 includes a processing device 1060 and a storage device 1062. The storage device 1062 is configured by, for example, a volatile and/or non-volatile semiconductor memory and/or a hard disk device. The processing device 1060 is a computer including a processor such as a CPU. The processing device 1060 may have a configuration include a ROM (storage medium) in which a program is written and a RAM in which data is temporarily stored. The processing device 1060 includes, as functional elements or functional units, a parking spot transmission unit 1064, an image providing unit 1066, an alarm control unit 1068, and a door control unit 1070.

Such functional elements included in the processing device 1060 are realized when the processing device 1060 serving as the computer executes a program. The computer program can be stored in any computer-readable storage medium. Alternatively, all or part of the functional elements included in the processing device 1060 may be configured by hardware including one or more electronic circuit components, respectively.

When detecting based on the information from the drive control device 1008 that the position of the shift lever of the vehicle 710 is set to parking and the vehicle 710 is set to the parking state, the parking spot transmission unit 1064 acquires the current position information of the vehicle 710 from the GPS receiver 1004. Then, the parking spot transmission unit 1064 transmits the acquired current position information, via the TCU 1006, to the guidance management server 708 as parking spot information.

When receiving the image request from the guidance management server 708, the image providing unit 1066 acquires the image captured by the in-vehicle camera 728, from the image acquisition device 1002. Specifically, for example, when an occupant of the vehicle 710 gets off the vehicle 710 in the case where the image request is received, the image providing unit 1066 acquires an external image (for example, an image of the user 702 leaving the vehicle 710) of the vehicle 710 captured by the in-vehicle camera 728. Then, the image providing unit 1066 transmits the acquired image, via the TCU 1006, to the guidance management server 708.

When receiving an alarm instruction from the guidance management server 708, the alarm control unit 1068 executes an alarm operation using sound and/or lighting. The alarm operation may include sounding of the horn 1030 or turning-on or flickering of the lighting devices such as head lamps 1032 and sidelights 1036 in the vehicle 710. Contents of the alarm operation can be determined in advance, or can be instructed by the alarm instruction from the guidance management server 708. The alarm control unit 1068 instructs the in-vehicle equipment control device 1010 to control the horn 1030, the head lamps 1032, the tail lamps 1034, the sidelights 1036, and the hazard lamps 1038, thereby executing the alarm operation.

When receiving the user state information and the door operation instruction from the guidance management server 708, the door control unit 1070 determines a vehicle door of the vehicle 710, which should be opened, from the vehicle doors including the driver door 1040 based on the received user state information. Then, the door control unit 1070 instructs the BCM 1012 to open the determined vehicle door. The opening operation may include an operation of unlocking the corresponding vehicle door to drive an actuator for opening and closing the door and an operation of opening the vehicle door. For example, when the received user state information indicates that the user 702 or the accompanying person is in possession of luggage or is using a walking assistance equipment such as a baby carriage, the door control unit 1070 may open not only the vehicle door for the user 702 and the accompanying person to get on but also the vehicle door (for example, the tailgate door 1048) for accommodating the luggage or the baby carriage.

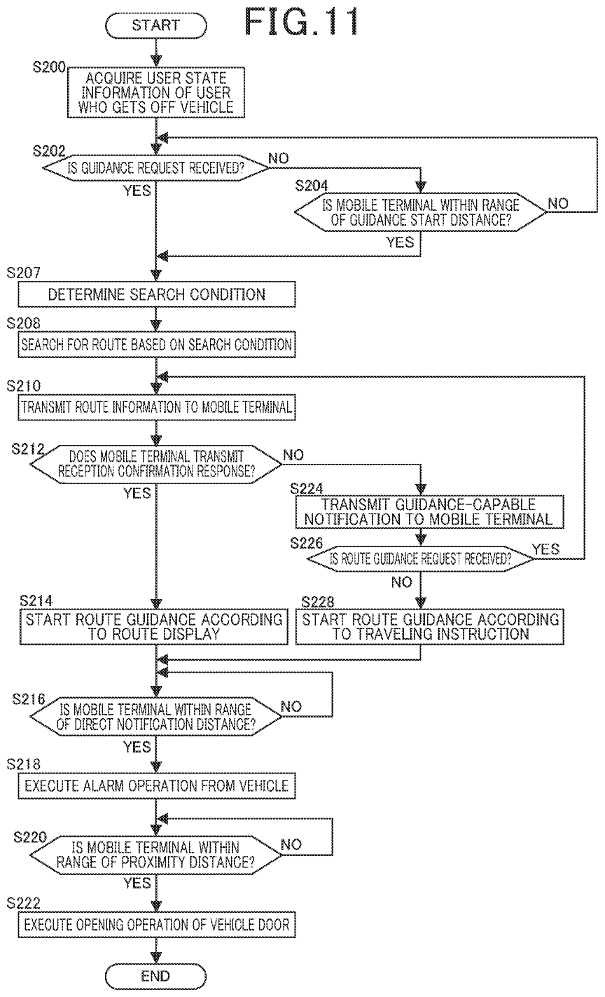

An operation of the route guidance system 700 will be described below. FIG. 11 is a flowchart showing a procedure of the operation of the route guidance system 700. Such a procedure starts when the guidance management unit 812 of the guidance management server 708 receives the parking spot information from the vehicle used by any of the registered users. In the following description, it is assumed that the flow shown in FIG. 11 is started by the reception of the parking spot information from the vehicle 710 (the in-vehicle guidance device 712) of the user 702 who is the registered user, as an example.

When the procedure starts, for example, the state acquisition unit 814 of the guidance management server 708 transmits an image request to the in-vehicle guidance device 712 of the vehicle 710 to acquire the image captured by the in-vehicle camera 728, and acquires user state information indicating the state of the user 702, who gets off the vehicle 710, from the image (S200). Next, the guidance management unit 812 of the guidance management server 708 determines whether a route guidance request is received from the mobile terminal 704 of the user 702 (S202). Then, when the route guidance request is not received (S202, NO), the guidance management unit 812 determines whether the mobile terminal 704 is within a range of a predetermined guidance start distance from the parking spot of the vehicle 710 (S204). Then, when the mobile terminal 704 is not within the range of the guidance start distance (S204, NO), the process returns to step S202 and the guidance management unit 812 repeats the process.

On the other hand, when the route guidance request is received in step S202 (S202, YES) or when the mobile terminal 704 is within the range of the guidance start distance in step S204 (S204, YES), the search condition determination unit 816 of the guidance management server 708 determines a search condition of the route based on the user state information acquired in step S200 (S206).

The route search unit 818 of the guidance management server 708 searches for a route from the current position of the mobile terminal 704 to the parking spot of the vehicle 710 based on the determined search condition (S208). Further, the route information transmission unit 820 of the guidance management server 708 transmits route information, which is information on the searched route, to the mobile terminal 704 (S210).

Subsequently, the guidance management unit 812 determines whether the mobile terminal 704 transmits a reception confirmation response depending on the transmission of the route information (S212). The guidance management unit 812 can determine whether the mobile terminal 704 transmits the reception confirmation response depending on whether a reception confirmation non-arrival notification is received from the route information transmission unit 820.

Here, when the reception confirmation response is transmitted, the application program serving as a program for terminal is executed on the mobile terminal 704, the route information acquisition unit 926 and the route guidance unit 928 are realized in the processing device 900, and thus the route guidance can be performed by the route display using the display device 408 of the mobile terminal 704. On the contrary, when the reception confirmation response is not transmitted, the application program serving as a program for terminal is not yet executed in the mobile terminal 704, and thus the route guidance cannot be performed by the route display using the display device 408 of the mobile terminal 704.

When the reception confirmation response is transmitted (S212, YES), based on the route information received by the route information acquisition unit 926, the mobile terminal 704 uses the route guidance unit 928 to start the route guidance by the route display using the display device 408 (S214).

Next, the guidance management unit 812 of the guidance management server 708 determines whether the mobile terminal 704 is within a range of a predetermined direct notification distance from the parking spot of the vehicle 710 (S216). Then, when the mobile terminal 704 is not within the range of the direct notification distance (S216, NO), the process returns to step S216 and the guidance management unit 812 waits until the mobile terminal 704 is within the range of the direct notification distance. For the period of time, the mobile terminal 704 continues to execute the route guidance started in step S214 or step S228 (which will be described below).

On the other hand, when the mobile terminal 704 is within the range of the direct notification distance (S216, YES), the guidance management unit 812 transmits an alarm instruction to the in-vehicle guidance device 712 of the vehicle 710, and executes an alarm operation of the vehicle 710 using the horn or the head lamps (S218). The alarm operation may be continued for a predetermined time, or may be continued until the opening operation of the vehicle door is executed in step S222 which will be described below.

Next, the guidance management unit 812 determines whether the mobile terminal 704 is within a range of a predetermined proximity distance from the parking spot of the vehicle 710 (S220). Then, when the mobile terminal 704 is not within the range of the proximity distance (S220, NO), the process returns to step S220 and the guidance management unit 812 waits until the mobile terminal 704 is within the range of the proximity distance. For the period of time, the mobile terminal 704 continues to execute the route guidance started in step S214 or step S228 (which will be described below).

On the other hand, when the mobile terminal 704 is within the range of the proximity distance (S220, YES), the guidance management unit 812 transmits the user state information and the door operation instruction to the in-vehicle guidance device 712 of the vehicle 710. Based on the received user state information, the door control unit 1070 of the in-vehicle guidance device 712, which has received the door opening operation instruction, determines a vehicle door which should be opened, and executes the opening operation of the determined vehicle door (S222). Thus, the procedure shown in FIG. 11 is ended.

On the other hand, when the guidance management unit 812 does not receive the reception confirmation response from the mobile terminal 704 in step S212 (S212, NO), the guidance management unit 812 transmits the guidance-capable notification (the notification indicating that the “route guidance is possible”) to the mobile terminal 704 (S224). The notification is transmitted in the form of the push notification as described above to the mobile terminal 704. On the other hand, the user 702 can execute the application program serving as the program for terminal on the mobile terminal 704 to realize the guidance request unit 924, the route information acquisition unit 926, and the route guidance unit 928 in the processing device 900. Thereafter, the user 702 can operate the touch panel 410, for example, and can transmit the route guidance request to the guidance management server 708 using the guidance request unit 924.

Subsequently, the guidance management unit 812 of the guidance management server 708 determines whether the route guidance request is received from the mobile terminal 704 within a predetermined time (for example, 5 minutes) from the transmission of the route information in step S210, for example (S226). Then, when the route guidance request is received (S226, YES), the process returns to step S210 and the guidance management unit 812 transmits the route information to the mobile terminal 704 again.

On the other hand, when the route guidance request is not received from the mobile terminal 704 in step S226 (S226, NO), the guidance management unit 812 starts the route guidance according to the traveling instruction to guide the user 702 to the route searched by the route search unit 818 (S228), and then the process shifts to step S216. Here, the route guidance according to the traveling instruction is performed when the guidance management unit 812 transmits the traveling instructions to turn right, turn left, and go straight with movement of the mobile terminal 704, to the mobile terminal 704 as described above. As described above, the traveling instruction is transmitted to the mobile terminal 704 in the push notification, for example, and the notification processing unit 922 of the mobile terminal 704, which has received the traveling instruction, notifies the user 702 of the traveling direction indicated by the traveling instruction using the display device 408, the vibrator 412, and/or the speaker 416 according to the content of the traveling instruction.

When it is determined based on the user registration information acquired in step S200 that the user 702 is not in a state where the user's own mobile terminal 704 can hardly be operated after the search condition determination unit 816 determines the search condition in the flowchart shown in FIG. 11 described above, for example, in step S208, the guidance management unit 812 of the guidance management server 708 can change the target of the route guidance to the mobile terminal (the mobile terminal 722 of the person 714 or the mobile terminal 724 of the person 716) of any one of the accompanying persons of the user 702. When the mobile terminal to be the target of the route guidance is changed, steps after step S210 can be performed on the changed mobile terminal.

The present invention is not limited to the configurations of the embodiments described above, and can be implemented in various aspects without departing from the gist of the invention.

For example, the route guidance is performed for one user 102 or 702 in the route guidance system 100 or 700, but the number of users to be the target of the route guidance is not limited to one person. Each of the route guidance systems 100 and 700 can perform the same operations as those for the users 102 and 702 described above in parallel for each of the plurality of users (registered users) to provide the route guidance.

In the route guidance system 700 described above, the search condition determination unit and the route search unit are provided in the guidance management server 708, but the location of such functional elements is not limited to the guidance management server 708. For example, the search condition determination unit and the route search unit may be provided in the mobile terminal 704 as in the mobile terminal 104-1 shown in FIG. 6 which is the modified example of the mobile terminal 104 of the route guidance system 100.

In the route guidance system 700 described above, the state acquisition unit 814 of the guidance management server 708 acquires the user state information of the user 702 who gets off the vehicle 710, but the configuration of the state acquisition unit 814 is not limited thereto. For example, the state acquisition unit 814 may newly acquire user state information when receiving the route guidance request from the mobile terminal 704, and may determine the search condition using the newly acquired user state information instead of the user state information acquired when the user 702 gets off the vehicle 710. In this case, in the scene shown in FIG. 7, for example, as shown on the right side of FIG. 7, the state acquisition unit 814 can acquire the user state information indicating that the user 702 is accompanied by the persons 714, 716, 718, and 720, the user 702 is carrying the luggage 750 while pushing the baby carriage 726 on which the person 718 sits, the person 714 is holding the person 718 who is an infant, and the person 716 is carrying the luggage 752. The state acquisition unit 814 can acquire the new user state information as described above, based on the images captured by the on-site cameras 732 and 734 provided in the shopping area, for example.

In the first embodiment described above, the guidance management server 108 of the route guidance system 100 does not include a configuration corresponding to the guidance management unit 812 included in the guidance management server 708 of the route guidance system 700, but the configuration of the guidance management server 108 is not limited thereto. For example, the guidance management server 108 includes a guidance management unit, and when it is determined, based on the user state information acquired by the state acquisition unit 212, that hands of the user 102 are full and thus the user 102 can hardly receive the route guidance from the mobile terminal 104, the guidance management unit can guide the user 102 to the route searched by the route search unit 216 via the mobile terminal 138 or 140 of any person 116 or 118 accompanied by the user 102. In this case, the persons 116 and 118 are, for example, registered users, and the guidance management unit can confirm the persons by face authentication based on the image of the streetlight camera 132. Further, the guidance management unit can acquire access information of the mobile terminals 138 and 140 of the persons 116 and 118, based on the registration information stored in the storage device 202.

As described above, the route guidance system 100 includes the route search unit 216 that searches for the route from the departure point to the destination point and the route guidance unit 426 that guides the user to the searched route. In addition, the route guidance system 100 includes the state acquisition unit 212 that acquires the user state information regarding the state of the user 102 and the search condition determination unit 214 that determines, based on the user state information acquired by the state acquisition unit 212, the search condition for searching the route. Then, the route search unit 216 searches for the route based on the search condition determined by the search condition determination unit 214. With such a configuration, a more appropriate route can be guided to the user 102 according to the state of the user 102.

In the route guidance system 100, the state acquisition unit 212 acquires the user state information when the user 102 departs from the departure point and/or when the route includes the waypoint and the user 102 departs from the waypoint. With such a configuration, since the route is searched based on the user state information acquired at the departure point or the waypoint where the user 102 starts moving most recently, more appropriate route guidance to the user 102 can be executed more reliably.

In the route guidance system 700, the destination point is the parking spot of the vehicle 710 used by the user 702, and the state acquisition unit 814 acquires the user state information when the user 702 gets off the vehicle 710. With such a configuration, the use state of the baby carriage or the wheelchair used after the user gets off the vehicle can be reliably acquired as the user state information, and appropriate route guidance to the user 702 can be executed.

In addition, the route guidance system 700 includes the guidance management unit 812 that manages the operation of guiding the user 702 to the route searched by the route search unit 818. The guidance management unit 812 notifies the mobile terminal 704 of the notification indicating that the route guidance is possible to the parking spot when the mobile terminal 704 of the user 702 is within the range of the predetermined guidance start distance from the parking spot of the vehicle 710. With such a configuration, the user 702 can be urged to execute the application program, which is the program for terminal for route guidance, on the mobile terminal 704.

In the route guidance system 100, the guidance management unit 812 guides the user to the route searched by the route search unit 818 via the mobile terminal of any person accompanied by the user 702 when determining, based on the user state information acquired by the state acquisition unit 814, that the user 702 is in a state of not being capable of receiving the route guidance through the user's own mobile terminal 704.

With such a configuration, even when the user 702 can hardly operate the mobile terminal 704, the route guidance can be indirectly performed for the user 702 via the accompanying person.

Further, the route guidance system 700 includes the door control unit 1070 that controls the opening operation of the vehicle door of the vehicle 710. The door control unit 1070 determines, based on the user state information of the user 702 acquired by the state acquisition unit 814, any vehicle door that should be subjected to the opening operation, and executes the opening operation on the determined vehicle door. With such a configuration, according to the state of the user 702 and the accompanying person, for example, the presence or absence of luggage and the use of the walking assistance equipment, the door for housing the luggage and the walking assistance equipment can be unlocked, and thus the convenience for the user 702 and the accompanying person can be improved.

Further, the processing devices 200 and 400 included in the route guidance system 100 cooperates with each other to execute a route guidance method. The route guidance method includes a step in which the route search unit 216 searches for a route from a departure point to a destination point and a step in which the route guidance unit 426 guides the user to the searched route. The route guidance method further includes a step in which the state acquisition unit 212 acquires user state information regarding the state of the user 102 and a step in which the search condition determination unit 214 determines a search condition of the route based on the user state information acquired by the state acquisition unit 212. In the step of searching, the route is searched based on the search condition. With such a configuration, a more appropriate route can be guided to the user 102 according to the state of the user 102.

In addition, the route guidance system 100 includes the guidance management server 108 including the processing device 200 which is a computer connected to the communication network 106, and the guidance management server 108 includes the state acquisition unit 212, the search condition determination unit 214, and the route search unit 216. With such a configuration, since a series of operations from the acquisition of the user state information to the route search is executed in the guidance management server 108, the processing load on the mobile terminal 104 of the user 102 can be reduced.

Further, the route guidance system 100 is capable of including the mobile terminal 104-1 of the user 102, and the mobile terminal 104-1 includes the search condition determination unit 614, the route search unit 616, and the route guidance unit 426. With such a configuration, the processing load of the guidance management server 108 can be reduced. In addition, with such a configuration, since the route search is performed on the mobile terminal 104-1, it is possible to easily customize the route search operation by adding the search condition according to the preference of the user 102.

In addition, the mobile terminal 104-1 forming the route guidance system 100 executes the program for terminal, which is the application program, using the processing device 600 which is a computer. The program for terminal causes the processing device 600 of the mobile terminal 104-1 to function as the route search unit 616, the search condition determination unit 614, and the route guidance unit 426. With such a configuration, the program for terminal is executed on the mobile terminal, and thus the mobile terminal can be easily configured as a part of the route guidance system 100.

### REFERENCE SIGNS LIST

100, 700 route guidance system
102, 702 user
104, 104-1, 138, 140, 704, 722, 724 mobile terminal
106, 706 communication network
108, 708 guidance management server
110 home
112 home camera
114 university
116, 118, 714, 716, 718, 720 person
120, 740 shopping mall
122, 132 streetlight camera
124, 134, 710 vehicle
126, 136 in-vehicle camera
128 crutch
130, 730, 732, 734 on-site camera
200, 400, 600, 800, 900, 1060 processing device
202, 402, 802, 902, 1062 storage device
204, 404, 804, 904 communication device
210, 810 user management unit
212, 814 state acquisition unit
214, 614, 816 search condition determination unit
216, 616, 818 route search unit
218, 820 route information transmission unit
406, 1004 GPS receiver
408 display device
410 touch panel
412 vibrator
414 microphone
416 speaker
420, 920 current position acquisition unit
422, 622, 924 guidance request unit
424, 926 route information acquisition unit
426, 928 route guidance unit
712 in-vehicle guidance device
726 baby carriage
728 in-vehicle camera
750, 752 luggage
922 notification processing unit
1000 in-vehicle network bus
1002 image acquisition device
1006 TCU
1008 drive control device
1010 in-vehicle equipment control device
1012 BCM
1026 shift position sensor
1030 horn
1032 head lamp
1034 tail lamp
1036 sidelight
1038 hazard lamp
1040 driver door
1042 passenger door
1044 rear right door
1046 rear left door
1048 tailgate door
1064 parking spot transmission unit
1066 image providing unit
1068 alarm control unit
1070 door control unit

What is claimed is:

1. A route guidance system comprising:
a route search unit that searches a route from a departure point to a destination point; and
a route guidance unit that guides a user to the searched route,
the route guidance system further including
a state acquisition unit that acquires user state information regarding a state of the user, and
a search condition determination unit that determines, based on the user state information acquired by the state acquisition unit, a search condition of the route,
the route search unit being configured to search for the route based on the search condition.

2. The route guidance system according to claim 1, wherein
the state acquisition unit acquires the user state information when the user departs from the departure point and/or when the route includes a waypoint and the user departs from the waypoint.

3. The route guidance system according to claim 1, wherein
the destination point is a parking spot of a vehicle used by the user, and
the state acquisition unit acquires the user state information when the user gets off the vehicle.

4. The route guidance system according to claim 3, further comprising:
a guidance management unit that manages an operation of guiding the user to the route searched by the route search unit,
the guidance management unit being configured to notify a mobile terminal of the user of a notification indicating that route guidance is possible to the destination point when the mobile terminal is within a range of a predetermined distance from the parking spot of the vehicle, which is the destination point.

5. The route guidance system according to claim 4, wherein
the guidance management unit guides the user to the route searched by the route search unit via a mobile terminal of any person accompanied by the user when determining, based on the user state information acquired by the state acquisition unit, that the user is in a state of not being capable of receiving the route guidance through the user's own mobile terminal.

6. The route guidance system according to claim 3, further comprising:
a door control unit that controls opening operation of doors of the vehicle,
the door control unit being configured to determine, based on the user state information acquired by the state acquisition unit, any of the doors that should be subjected to the opening operation, and to execute the opening operation on the determined target door.

7. A route guidance method comprising:
a step in which a route search unit searches for a route from a departure point to a destination point; and
a step in which a route guidance unit guides a user to the searched route,
the route guidance method further including
a step in which a state acquisition unit acquires user state information regarding a state of the user, and
a step in which a search condition determination unit determines a search condition of the route based on the user state information acquired by the state acquisition unit,
the route being searched based on the search condition in the step of searching.

8. A server comprising a computer forming the route guidance system according to claim 1 and connected to a communication network, the server including the route search unit, the state acquisition unit, and the search condition determination unit.

9. A mobile terminal of a user, the mobile terminal forming the route guidance system according to claim 1,
the mobile terminal including the route search unit, the search condition determination unit, and the route guidance unit.

10. A non-transitory computer-readable storage medium storing a program for terminal to be executed by a processor of a computer included in a mobile terminal of a user, the mobile terminal forming the route guidance system according to claim 1,
the program for terminal causes the professor functions as the route search unit, the search condition determination unit, and the route guidance unit.
